(19) United States
(12) Patent Application Publication
(10) Pub. No.: US 2010/0008642 A1
(43) Pub. Date: Jan. 14, 2010

(54) VIDEO APPARATUS AND METHOD THEREOF

(75) Inventors: Te Chien CHEN, Taipei City (TW); Chun-Kuang HU, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/172,514

(22) Filed: Jul. 14, 2008

(51) Int. Cl. H04N 5/91

(52) U.S. Cl. 386/68

(57) ABSTRACT

A video apparatus and a method of reverse playing video data. The video apparatus includes a controller, a first memory, a second memory, a video decoder, and a display device. The controller obtains a first and second group of pictures (GOP) from a data storage medium. The first memory, coupled to the controller, receives the first GOP. The second memory, coupled to the controller, receives the second GOP. The video decoder, coupled to the first and second memories, decodes video frames in the first and second GOPs. The display device, coupled to the video decoder, displays the decoded video frames. Concurrently, the second memory receives the second GOP, and the video decoder decodes the video frames in the first GOP and then the display device displays the decoded video frames in the first GOP in a reverse playback order.

### BACKGROUND OF THE INVENTION

1. Field of the Invention

The invention relates in general to video displaying, and in particular, to a video apparatus and method of reverse playing video data.

2. Description of the Related Art

Various functionalities, such as reverse playback, are implemented in video apparatuses in order to conveniently manipulate video data. Video apparatuses typically employ video coding standards such as MPEG 1/2/4 and H.26x to perform digital data manipulation and compression. In general, video encoders and decoders conforming to the video coding standards process video data according to a forward time order. Consequently, in reverse playback applications, display devices need to wait for the video decoders to complete sequential decoding of all video data in forward time, before displaying the video in reverse, resulting in display latency due to video data buffering and decoding.

Therefore, there exists a need to provide a video apparatus and method of reverse playing video data to reduce the display latency.

### BRIEF SUMMARY OF THE INVENTION

A detailed description is given in the following embodiments with reference to the accompanying drawings.

A video apparatus capable of reverse playing video data is provided, comprising a controller, a first memory, a second memory, a video decoder, and a display device. The controller obtains a first and second group of pictures (GOP) from a data storage medium. The first memory, coupled to the controller, receives the first GOP. The second memory, coupled to the controller, receives the second GOP. The video decoder, coupled to the first and second memories, decodes video frames in the first and second GOPs. The display device, coupled to the video decoder, displays the decoded video frames. Concurrently, the second memory receives the second GOP, and the video decoder decodes the video frames in the first GOP and then the display device displays the decoded video frames in the first GOP in a reverse playback order.

According to another aspect of the invention, a method for reverse playing video data is disclosed, comprising obtaining first and second group of pictures (GOP) from a data storage medium by a controller, receiving the first GOP by a first memory, and concurrently receiving the second GOP by a second memory, decoding the first GOP by a video decoder, and displaying the decoded GOP in a reverse playback order by a display device.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary video apparatus according to an embodiment of the invention.

FIG. 2 shows a forward playback scheme for MPEG encoded video frames in a group of pictures (GOP).

FIG. 3 shows a reverse playback scheme for MPEG encoded video frames in a GOP.

FIG. 4 shows a conventional reverse playback scheme.

FIG. 5 shows an exemplary reverse playback scheme according to an embodiment of the invention.

FIG. 6 illustrates another exemplary reverse playback scheme according to another embodiment of the invention.

FIG. 7 shows yet another exemplary reverse playback scheme according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

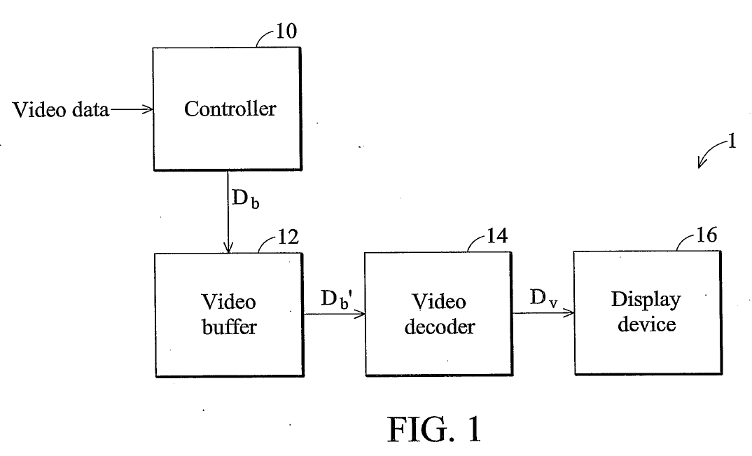

FIG. 1 is a block diagram of an exemplary video apparatus according to the invention, comprising a controller 10, a video buffer 12, a video decoder 14, and a display device 16. The controller 10 is coupled to the video buffer 12, the video decoder 14, and subsequently to the display device 16.

The video apparatus 1 can be incorporated into a video playback system or a television system. In the case of a video playback system, video data are compressed according to coding standards such as MPEG 1/2/4 and H.26x and stored in data storage media such as CDs or DVDs. In the case of a television system, an antenna, a satellite dish, or a cable (not shown) picks up TV signals, a TV tuner (not shown) tunes into the channel carrying the request program in the TV signals, and a demodulator (not shown) demodulates the TV signals to provide video data compliant with a coding standard including MPEG 1/2/4, or H.26x. A remote control device or other user interface (not shown) is used to select a data section on the data storage media or the channel for viewing. The controller 10 obtains the video data from the data storage media (not shown) or the demodulator (not shown) to buffer a bitstream Db in the video buffer 12 prior to performing decoding in the video decoder 14.

The video buffer 12 may be standalone data buffers or built into the video decoder 14. The video decoder 14 receives bitstream Db′ from the video buffer 12 to decode a set of video frames Dv, referred to as a group of pictures (GOP) including a frame sequence of intra (I-frame), prediction (P-frame), or bidirectional (B-frame) frames. An I-frame is usually the first frame of a GOP, and is encoded without motion compensation, as a normal image. A P-frame is predicted from the I-frame or P-frame that is immediately preceding it. A B-frame is predicted bidirectionally from preceding and successive I-frames or P-frames. The predictive coding and decoding of P-frames and B-frames are dependent on the preceding and successive video frames, thus decoding the last predictive video frame typically requires decoding the reference frames near the end of the GOP. Therefore, decoding the last B-frame of the bitstream Db′ requires decoding all of the preceding reference frames including I-frame and P-frame first. During normal playback, the video decoder 14 decodes the encoded video frames in a forward decoding order when the video display 16 displays the decoded video frames in a similar forward playback order, whereas during reverse playback, the video decoder 14 has to decode the encoded video frames in the forward decoding order before the video display 16 displays the decoded frames in reverse playback order.

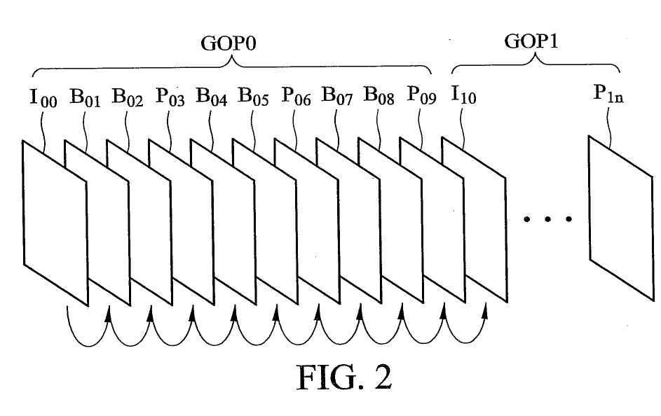

FIG. 2 shows a forward playback scheme for MPEG encoded video frames in a GOP, comprising a first GOP0 and a second GOP1. Each video frame in the GOPs is represented by a letter indicating the type of frame and a number indicating the GOP number and displaying order in the normal playback sequence. For example, I₀₀ is an I-frame and the first video frame to be displayed in the group of picture GOP0, and P₀₆ is a P-frame and the seventh video frame in group of picture GOP0. Taking the first group of picture GOP0 as an example, the video decoder 14 receives bitstream Db′ from the video buffer 12, decodes the encoded video frames in the order {I₀₃, P₀₃, B₀₁, B₀₂, P₀₆, B₀₄, B₀₅, P₀₉, B₀₇, B₀₈}, and passes the decoded video frames Dv to the display device 16 to be displayed in forward playback order {I₀₀, B₀₁, B₀₂, P₀₃, B₀₄, B₀₅, P₀₆, B₀₇, B₀₈, P₀₉}, indicated by the arrow directions in FIG. 2. It is observed that the decoding order and forward playback order are similar, thus the normal playback of decoded video frames can be performed seamlessly on the display device 16.

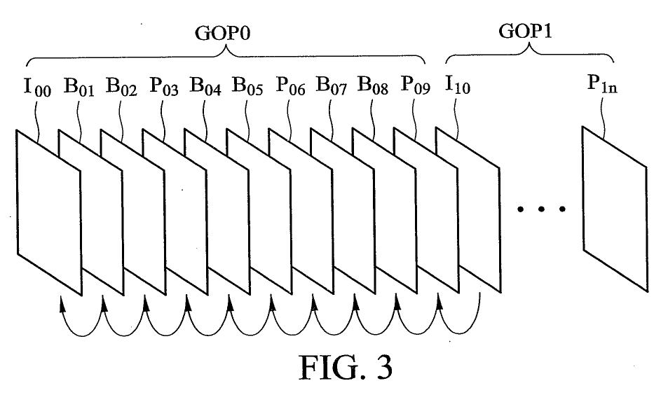

FIG. 3 shows a reverse playback scheme for MPEG encoded video frames, comprising a first group of picture GOP0 and a second group of picture GOP1. During the reverse playback, the video decoder 14 may decode all encoded video frames in the GOP, or selective encoded video frames therein, for example, decoding I-frame and P-frames only during the reverse playback. In the exemplary reverse playback scheme, all encoded video frames in the GOPs are decoded in a forward decoding order and displayed in a reverse playback order. For example, the video decoder 14 receives bitstream Db′ from the video buffer 12, decodes the encoded video frames in the order of {I₀₀, P₀₃, B₀₁, B₀₂, P₀₆, B₀₄, B₀₅, P₀₉, B₀₇, B₀₈}, and passes the decoded video frames Dv to the display device 16 to be displayed in reverse playback order {P₀₉, B₀₈, B₀₇, P₀₆, B₀₅, B₀₄, P₀₃, B₀₂, B₀₁, I₀₀}, indicated by the arrow directions in FIG. 3. It is observed that the decoding order and reversed playback order are operated in almost opposite order, consequently, the display device 16 has to wait for the video decoder 14 to complete MPEG decoding for all encoded frames of the first group of picture GOP0 before displaying the decoded video frames in reversed playback order, resulting in a display latency proportional to the number of encoded video frames in the group of picture to be decoded in the conventional video apparatus.

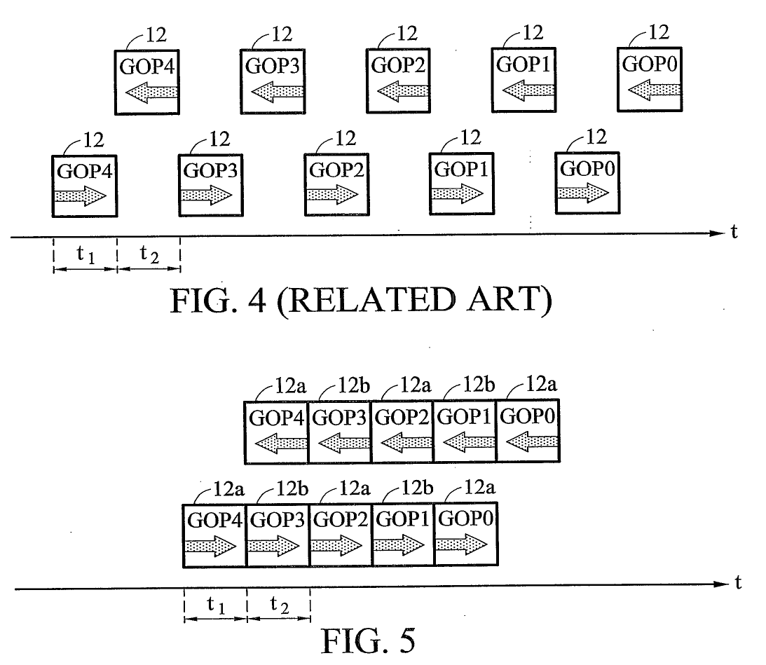

FIG. 4 shows a conventional reverse playback scheme using a conventional video apparatus. In the conventional reverse playback scheme, the video buffer 12 receives the bitstream Db for the group of picture GOP4 during duration t1, and the video decoder 14 decodes all encoded video frames in the group of picture GOP4 in forward time sequence and the display device 16 displays the decoded video frames Dv in reverse playback order during duration t2. The process of the video buffer 12 receiving a GOP prior to decoding and displaying is known as “rebuffering”. Before the next preceding GOP (GOP4) is played back on the display device 16, the video buffer 12 requires a finite amount of time t1 to rebuffer the bitstream Db for the group of picture GOP4, and the video decoder 14 also needs time to decode all encoded video frames in the GOP4, consequently, the viewer would experience image latency on the display device 16 when viewing a reverse played video.

FIG. 5 shows an exemplary reverse playback scheme according to an embodiment of the invention, incorporating the video apparatus 1 in FIG. 1. The video buffer 12 comprises separate video memories 12a and 12b (first and second memories). As depicted in FIG. 5, the memory 12a receives the bitstream Db for the last group of picture GOP4 (first GOP in reverse playback order) in the time duration t1. The video decoder 14 and the display devices 16 receives the rebuffered bitstream Db′ from the memory 12a to decode and display the video frames in the GOP4 in the time duration t2, while the video buffer 12b concurrently receives the bitstream Db for the next preceding group of picture GOP3 (second GOP in reverse playback order). The data retrieval of the next preceding GOP and the decoding and reverse playing of the present GOP are executed in parallel to reduce the display latency due to data rebuffering.

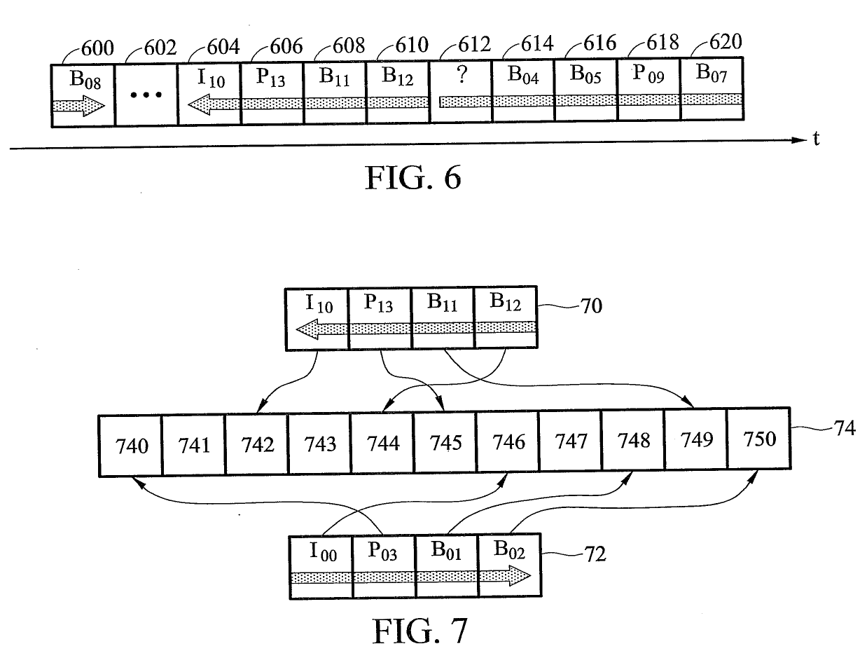

FIG. 6 illustrates another exemplary reverse playback scheme according to another embodiment of the invention, incorporating the video apparatus 1 in FIG. 1. The exemplary video buffer 12 comprises two memory portions (first and second memory portions) on one common memory, i.e., the first video memory portion represented by the memory blocks 604-610 and the second video memory portion represented by the memory blocks 612-620 and 600-602. Each memory block contains an encoded video frame, each encoded video frame is represented by a letter indicating the type of the frame, and a double-digit number indicates the GOP number and displaying order in the forward playback order. For example, I₁₀ represents an I-frame and the first encoded video frame in first group of picture GOP1, and B₀₅ presents a B-frame and the sixth encoded video frame in second group of picture GOP0. Upon the initiation of the reverse playback, the controller 10 controls the video buffer 12 to receive and store the last GOP of a selected video clip, which is also the first GOP decoded and displayed when in reverse playback. During the video decoding, the controller 10 concurrently controls the video buffer 12 to transfer the encoded video frames of the first GOP to the video decoder 14 for decoding encoded video frames of the first GOP, and controls the available video buffer 12 to receive and store the next preceding GOP (the second GOP in reverse playback order). The controller 10 controls the video buffer 12 to release available memory space after the encoded video frames are transferred to the video decoder 14 and decoded and displayed thereby. The memory space is released in reverse time sequence, i.e., releasing memory space storing the last video frame in the GOP first and the first video frame last after the encoded frames are decoded and displayed, and consequently the controller 10 is able to determine the available memory space for the next preceding GOP. Taking the data configuration in the common memory in FIG. 6 as an example, the encoded video frames of GOP1 following the P-frame P₁₃, such as the encoded video frames P₁₉, B₁₈, B₁₇, P₁₆, B₁₅, and B₁₄, have been read and decoded by the video decoder 14 and displayed accordingly, leaving the memory blocks 612-620 and 600-602 available. The controller 10 then checks data size of encoded video frames of the next preceding GOP to determine the number of encoded video frames to be rebuffered in the memory blocks 612-620 and 600-602, such that the available memory space can store the middle to the last encoded video frames of the next preceding GOP GOP0. For example, the controller 10 determines the memory blocks 612-620 and 600-602 are capable of storing at least five encoded video frames of the next preceding GOP GOP0, i.e., B₀₄, B₀₅, P₀₉, B₀₇, and B₀₈, reads the bitstream Db to search for a frame header of the fifth encoded video frame i.e., encoded video frame B₀₄, and controls the memory blocks 612-620 and 600-602 to receive these encoded video frames in forward decoding order. In an embodiment of the invention, the common memory is a ring buffer so that the encoded video frame B₀₇ is stored in memory block 620 and the encoded video frame B₀₈ is stored in memory block 600. Upon completion of the video decoding for the last GOP, the display device 16 display the decoded video frames in reverse playback order, while the common memory continues to receive the remaining encoded video frames of the next preceding GOP GOP0, i.e., I₀₀, B₀₁, B₀₂, P₀₃, and B₀₄). It is noted that the encoded frames of GOPs are selected to be stored in the common memory of FIG. 6 in a reverse time sequence, i.e., selecting the last video frame in the GOP first and the first video frame last, and placing in the common memory in accordance with their decoding order; however, designers may adjust the storing and arrangement order of encoded frames of GOPs according to design necessity.

FIG. 7 shows yet another exemplary reverse playback scheme according to another embodiment of the invention, incorporating the video apparatus 1 in FIG. 1, except the video buffer 12 is replaced by video memory 74. The controller 10 contains a first address table 70 and a second address table 72 comprising memory addresses pointing to the video memory 74 for the encoded video frames of the first and second GOPs. For example, the first address table 70 keeps track of the memory addresses for encoded video frames of the first GOP GOP1, and the second address table 72 stores the memory addresses for encoded video frames of the second GOP GOP0. The controller 10 concurrently controls the video memory 74 to receive the second GOP GOP0 according to the second address table 72 and to transfer the first GOP GOP1 to the video decoder 14 according to the first address table 70. For example, the second address table 72 keeps the address of memory 746 which stores the encoded frame I₀₀ of the GOP0. Similarly, the first address table 70 keeps the address of memory 742 which stores the encoded frame I₁₀ of the GOP1.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A video apparatus capable of reverse playing video data, comprising:
a controller, obtaining first and second group of pictures (GOP) from a data storage medium;
a first memory, coupled to the controller, receiving the first GOP;
a second memory, coupled to the controller, receiving the second GOP;
a video decoder, coupled to the first and second memories, decoding video frames in the first and second GOPs; and
a display device, coupled to the video decoder, displaying the decoded video frames; and
wherein the second memory receives the second GOP, and concurrently, the video decoder decodes video frames in the first GOP and then the display device displays the decoded video frames in the first GOP in a reverse playback order.

2. The video apparatus of claim 1, wherein the controller further controls the first memory to receive the first GOP, and then controls the second memory to concurrently receive the second GOP and the first memory to transfer the first GOP to the video decoder.

3. The video apparatus of claim 2, wherein the first and second memories are located in a common memory, the controller determines available memory space of the common memory while the first GOP is transferred from the common memory to the video decoder, determines a number of video frames of the second GOP that can be fit into the available memory space, and concurrently controls the common memory to transfer remaining video frames of the first GOP to the video decoder and to receive the video frames of the second GOP in the available memory space.

4. The video apparatus of claim 2, wherein the first and second memories are located in a common memory, the controller keeps a first and second address tables comprising memory addresses pointing to the common memory for the video frames of the first and second GOPs respectively, and the controller concurrently controls the common memory to receive the second GOP and to transfer the first GOP to the video decoder according to the second and the first address tables.

5. The video apparatus of claim 1, wherein the first and second memories are located on separated memories.

6. The video apparatus of claim 1, wherein the video decoder decodes all video frames of the first and second GOPs.

7. A method for reverse playing video data, comprising:
obtaining first and second group of pictures (GOP) from a data storage medium by a controller;
receiving the first GOP by a first memory; and
concurrently receiving the second GOP by a second memory, decoding the first GOP by a video decoder, and displaying the decoded GOP in a reverse playback order by a display device.

8. The method of claim 7, wherein the receiving steps comprise the controller controlling the first memory to receive the first GOP, and then concurrently controlling the second memory to receive the second GOP and the first memory to transfer the first GOP to the video decoder.

9. The method of claim 7, wherein the first and second memories are located in a common memory, and the receiving steps comprise the controller determining available memory space of the common memory while the first GOP is transferred from the common memory to the video decoder, determining a number of video frames of the second GOP that can be fit into the available memory space, and controlling the common memory to concurrently transfer remaining frames of the first GOP to the video decoder and receive the video frames of the second GOP in the available memory space.

10. The method of claim 7, wherein the first and second memories are located in a common memory, the receiving steps comprises the controller keeping first and second address tables comprising memory addresses pointing to the common memory for the video frames of the first and second GOPs respectively, and the controller concurrently controlling the common memory to receive the second GOP and to transfer the first GOP to the video decoder according to the second and the first address tables.

11. The method of claim 7, wherein the first and second memories are located on separated memories.

12. The method of claim 7, wherein the decoding step comprises the video decoder decoding all video frames of the first and second GOPs.
